(19) United States
(12) Patent Application Publication
(10) Pub. No.: US 2025/0331684 A1
(43) Pub. Date: Oct. 30, 2025

(54) SYSTEMS AND METHODS FOR PRODUCING WHIPPED FOOD PRODUCT

(71) Applicant: Vita-Mix Management Corporation, Olmsted Township, OH (US)

(72) Inventor: Thomas Clynne, Olmsted Township, OH (US)

(73) Assignee: Vita-Mix Management Corporation, Olmsted Township, OH (US)

(21) Appl. No.: 19/188,811

(22) Filed: Apr. 24, 2025

Related U.S. Application Data
(60) Provisional application No. 63/638,706, filed on Apr. 25, 2024.

(51) Int. Cl. A47J 43/12; A23C 13/12

(52) U.S. Cl. CPC A47J 43/128; A23C 13/12; A23C 2210/30

(57) ABSTRACT

Disclosed herein are systems for producing whipped food product. The systems include a compressor having an inlet that receives ambient air and an outlet that provides pressurized ambient air. The systems include a first disconnect coupling coupled to the compressor to receive pressurized ambient air. The systems include a charger. The charger includes a container having a chamber for holding food product, a second disconnect coupling in fluid communication with the chamber and couplable to the first disconnect coupling to provide pressurized ambient air to the chamber from first disconnect coupling, a dispense valve, and a nozzle connected to the dispense valve.

### CROSS-REFERENCE TO RELATED APPLICATION

This application claims priority to and all the benefits of co-pending U.S. Provisional Patent Application No. 63/638,706 filed on Apr. 25, 2024, for “System and Method for Whipped Cream Dispensing,” which is herein incorporated by reference in its entirety.

### TECHNICAL FIELD

The present specification generally relates to food preparation systems and methods and, more specifically, to systems and methods for producing whipped food product.

### BACKGROUND

Some drinks and food items incorporate or use whipped cream, whipped liquids, or other whipped or foamed food products. Some popular options for these whipped and foamed food products may include dairy items, such as milk, cream, skim milk, and the like, as well as non-dairy based items, including non-dairy creamers, almond milk, cashew milk, coconut milk, oat milk, other plant or nut based milks and creams, and the like. Whipped and foamed food products may be made by incorporating small bubbles of gas into the food product, such as 36% milk fat cream. Whipped and foamed food products may be made by mechanical whipping or via gas expansion of the food product by the introduction of a gas such as nitrous oxide (N₂O) under pressure into the fat portion of the food product. Given some drawbacks that are involved with the introduction of a gas, there exists a need for alternatives for incorporating air into food products.

### SUMMARY

In one aspect, systems for producing whipped food product include a compressor having an inlet that receives ambient air and an outlet that provides pressurized ambient air. The systems include a first disconnect coupling coupled to the compressor to receive pressurized ambient air. The systems include a charger. The charger includes a container having a chamber for holding food product. The charger includes a second disconnect coupling in fluid communication with the chamber and couplable to the first disconnect coupling to provide pressurized ambient air to the chamber from first disconnect coupling. The charger includes a dispense valve. The charger includes a nozzle connected to the dispense valve.

In another aspect, methods for producing whipped food include placing food product into a chamber of a charger. The method includes connecting the charger to a filling station. The method includes providing pressurized ambient air to the chamber of the charger with the filling station. The method includes disconnecting the charger from the filling station. The method includes dispensing whipped food product from a nozzle of the charger by actuating a dispense valve of the charger.

These and additional features provided by the examples described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a component diagram of a system for producing whipped food product, according to one or more embodiments shown and described herein;

FIG. 2 schematically depicts a component diagram of another system for producing whipped food product, according to one or more embodiments shown and described herein;

FIG. 3 schematically depicts a component diagram of an air compression system and filling stations, according to one or more embodiments shown and described herein;

FIG. 4 schematically depicts a perspective view of a filling station and a charger, according to one or more embodiments shown and described herein;

FIG. 5 schematically depicts a cross section view of a charger, according to one or more embodiments shown and described herein;

FIG. 6 schematically depicts a cross section view of a charger without a dispensing assembly attached thereto, according to one or more embodiments shown and described herein;

FIG. 7 schematically depicts a cross section view of the charger of FIG. 6 with the dispensing assembly attached thereto, according to one or more embodiments shown and described herein; and

FIG. 8 depicts a follow chart illustrating a steps for producing whipped food product, according to one or more embodiments shown and described herein.

### DETAILED DESCRIPTION

Embodiments described herein are directed to systems and methods that utilize pressurized ambient air to whip food product and thereby minimize or limit the use and inclusion of nitrous oxide, carbon dioxide, or manual whipping/foaming processes. The systems and methods described herein include an air compression system and a charger. The charger is couplable to the air compression system via disconnect couplings such that air compressed by the air compression system can be provided to the charger to whip food product contained therein. Various embodiments of the systems and methods for operation of the systems are described in more detail herein.

When the food product is allowed to expand from a higher-pressure state to atmospheric pressure, a foaming process is created whereby the gas dissolved into a fat portion of the food product evolves into small bubbles formed as the gas expands. This has been completed by dissolving N₂O under approximately 100-150 psi pressure into the food product so that an expansion to room pressure evolves N₂O from solution and creates bubbles. Whipped cream formed from N₂O can suffer from “weeping” or melting, where the whipped cream loses its form as it sits for a certain, generally short, period of time.

While there are other gases that have been used, such as carbon dioxide (CO₂) for example, these other gases can impart chemical changes into the food product, thereby causing flavor changes. In addition, N₂O is a damaging greenhouse gas, approximately 300 times more damaging than CO₂. The canisters that are used to store and use N₂O also cause unwanted waste that can be significant with large scale use. Additionally, N₂O is an anesthetic agent that can be subject to misuse and/or being stolen for illegitimate use.

Mechanical whipping can also have limitations. For one, mechanical whipping generally does not achieve the same expansion ratio and consistency of whipped cream compared to N₂O. Attempts to achieve the same expansion ratio or similar consistency with mechanical whipping involves more time and effort, and can risk overworking the food product so that it is unable to keep its form.

Whenever possible, the same reference numerals will be used throughout the drawings to refer to the same or like parts. It is to be understood that other embodiments may be utilized, and structural and functional changes may be made without departing from the scope of the present teachings. Moreover, features of the embodiments may be combined, switched, or altered without departing from the scope of the present teachings, e.g., features of each disclosed embodiment may be combined, switched, or replaced with features of the other disclosed embodiments. As such, the following description is presented by way of illustration and does not limit the various alternatives and modifications that may be made to the illustrated embodiments and still be within the spirit and scope of the present teachings.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom, above, below, etc.—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

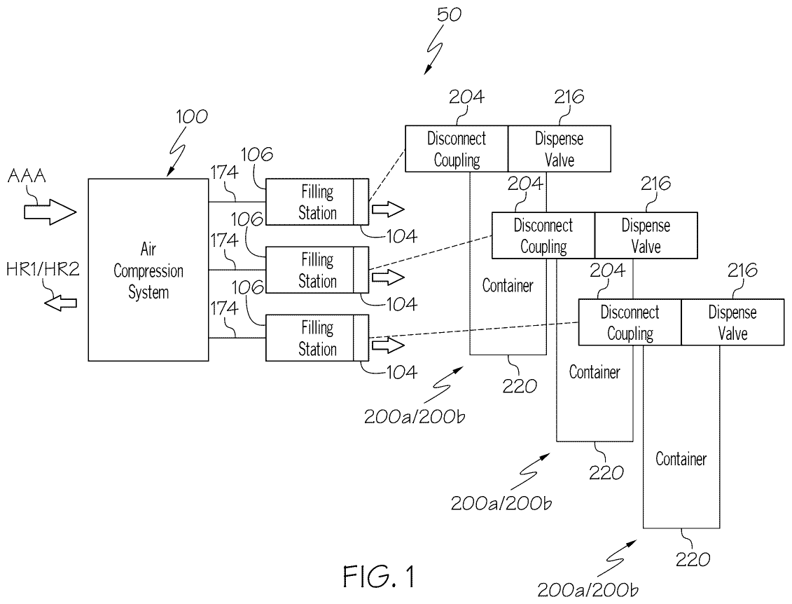

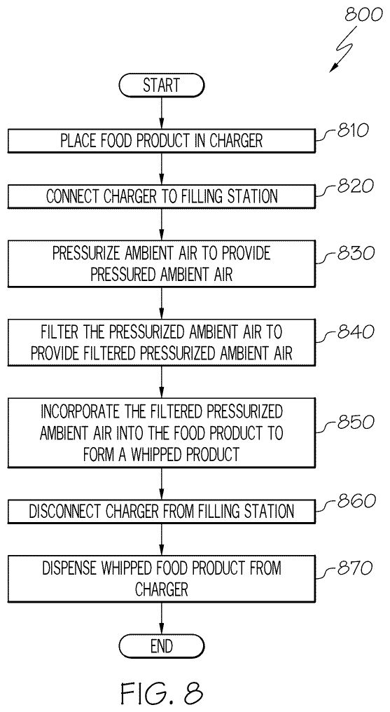

Referring now to FIG. 1, a system 50 for producing whipped food product is illustrated according to one or more embodiments described herein. The system 50 may be used to perform a method 800 to produce whipped food product (see, e.g., FIG. 8 as discussed below). The system 50 may generally include an air compression system 100, one or more a filling stations 106, and one or more chargers 200a, 200b. The air compression system 100 is configured to compress atmospheric ambient air AAA and the filling stations 106 facilitate transfer of the compressed air to the chargers 200a, 200b. For example, the air compression system 100 may be coupled to the filling stations 106 via tubing 174 or the like such that pressurized ambient air can flow from the air compression system 100 to the filling stations 106. Disconnect couplings 204 of the chargers 200a, 200b may be operative coupled to disconnect couplings 104 of the filling stations 106 such that pressurized ambient air from the filling stations 106 can be provided to containers 220 of the chargers 200a, 200b to whip food product contained therein. Each charger 200a, 200b, may include a dispense valve 216 that can be utilized for dispensing whipped food product from the container 220 of the respective charger 200a, 200b.

The chargers 200a, 200b and the filling stations 106 of the system 50 may be located in a different location than the air compression system 100 of the system 50. For example, the charger 200a, 200b and the filling station 106 may be provided on a countertop in a front room or the like, and the air compression system 100 may be provided in a utility room, basement or the like. Separating the air compression system 100 and the filling station 106 may be desirable to avoid noise, to allow higher performance and capacity components to be used, etc. Alternatively, the system 50, including air compression system 100, the filling stations 106, and the chargers 200a, 200b may be provided and used in the same area. For example, the air compression system 100, or various components thereof and discussed herein, may be incorporated into the filling station 106, e.g., as a unified and single assembly.

A scale of the system 50, including scales of components of the air compression system 100, the filling stations 106, and chargers 200a, 200b may be adapted for restaurant or larger scale use, for home use or smaller scale use, for individual use, and the like. The presence, size, location, and run time of components of the air compression system 100 can be adapted to suit the different environments as desired.

In an embodiment, the system 50 may include one or more sterilization mechanisms (not shown) to provide sterilization and reuse of the system 50 and components thereof. For example, the described system 50 and method 800 may use a “clean in place” system in which disinfectant may be added to the system 50, pressurized, and dispensed out.

In an embodiment, the described system 50 and method 800 can form whipped cream from ambient air. In an example, the described system 50 and method 800 can form whipped cream from cream having a fat content of 36% that does not weep and melt like N₂O whipped cream and that can last for a longer time without significant physical changes. In an example, the described system 50 and method 800 may be used to provide whipped butter. In an example, the described system 50 and method 800 may be used to provide whipped butter that does not release buttermilk as part of the process resulting in low-fat whipped butter. In an example, the described system 50 and method 800 can provide decreased charger fill times. It is noted that the described system 50 and method 800 are not limited to cream and milk products, but may be used for a variety of other food products that include foaming or high pressure air.

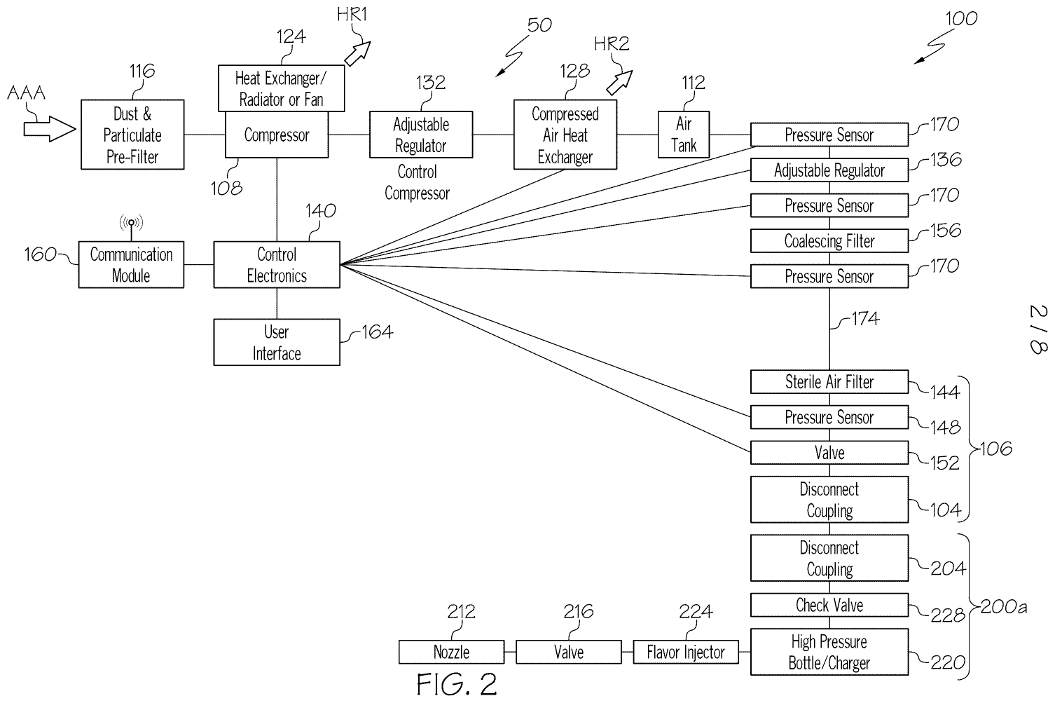

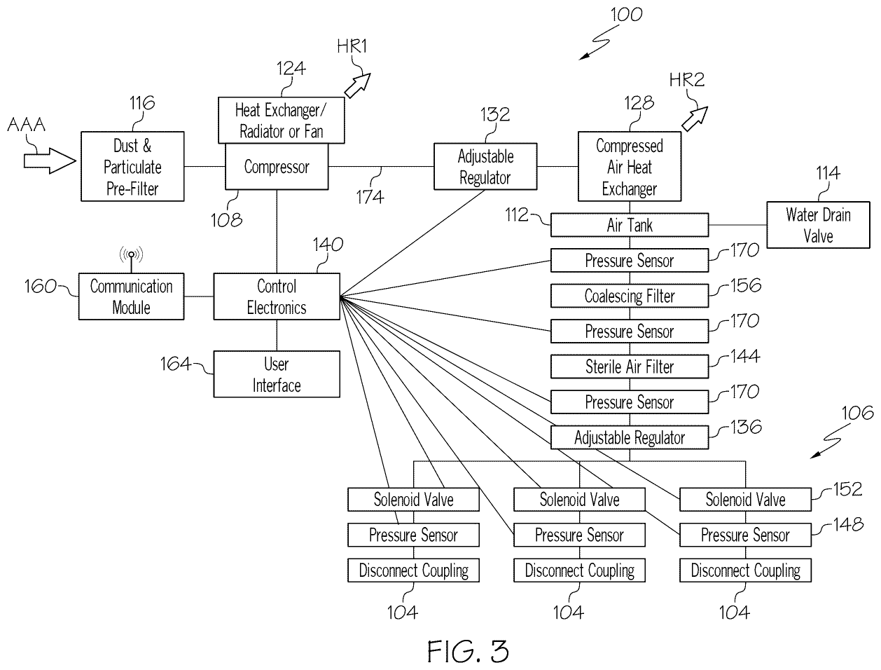

With reference to FIGS. 2 and 3, various components of the air compression system 100 are schematically shown. The air compression system 100 may provide bulk pressurization of a larger quantity of atmospheric ambient air AAA. The pressurized ambient air can be provided to the chargers 200a, 200b, which may be smaller in scale to allow for ease of use, portability of the chargers 200a, 200b, refrigeration of the chargers 200a, 200b, and the like. The air compression system 100 includes a compressor 108 that compresses atmospheric ambient air AAA, e.g., to a determined pressure. The compressor 108 having an inlet that receives atmospheric ambient air AAA and an outlet that provides pressurized ambient air The compressor 108 compresses atmospheric ambient air AAA to increase the pressure of the ambient air by reducing volume of the ambient air. The compressor 108 may be a positive displacement compressor, a reciprocating compressor, a rotary screw compressor, a rotary vane compressor, a rolling piston compressor, a scroll compressor, a diaphragm compressor, or other suitable structure for increasing pressure of a gas. The compressor 108 may be single-stage or multi-stage.

The compressor 108 may be configured to pressurize atmospheric ambient air AAA at about 500 to about 4000 per square inch (psi). In an embodiment, the compressor 108 may be configured to pressurize atmospheric ambient air AAA at about 3000 psi and greater. In an embodiment, the compressor 108 may be configured to pressurize atmospheric ambient air AAA at about 3000 to 4000 psi. In an embodiment, the compressor 108 may be configured to pressurize atmospheric ambient air AAA at high pressures. For example, the compressor 108 may be a fixed high pressure configured to pressurize atmospheric ambient air AAA at about 4500 psi. It is noted that the compressor 108 may work to provide on demand pressurized air, may turn on after a certain threshold of air has been dispensed (e.g., to the chargers 200a, 200b), turn on/off during certain times, or turn on/off based on any other factors, e.g., as commanded by control electronics 140 of the system 50.

The compressor 108 may include a heat exchanger 124 to cool the compressor 108. The heat exchanger 124 may provide removal of heat HR1 that may be generated during the compression of the atmospheric ambient air AAA. The heat exchanger 124 may include a radiator, a heat sink, tubing carrying a heat transfer fluid, a fan, heat transfer plates or fins, and/or other suitable structure for removing heat from a structure. The heat exchanger 124 may be a single-phase heat exchanger in which heat transfer fluid maintains phase state, e.g., liquid. The heat exchanger 124 may be a multi-phase heat exchanger in which heat transfer fluid changes phase state, e.g., from liquid to gas and vice versa.

The air compression system 100 may include a pre-filter 116 that is included to filter the atmospheric ambient air AAA before uptake by the compressor 108. The pre-filter 116 may be upstream of the compressor 108 relative to a direction of ambient air flow through the system 50. The pre-filter 116 may be configured to remove larger dust and particulates from the atmospheric ambient air AAA received by the compressor 108. For example, the pre-filter 116 may have a filtration size of about 1 micrometer. Alternately, the pre-filter 116 may have a higher or lower filtration size.

The air compression system 100 may include an adjustable regulator 132. The adjustable regulator may control the pressure of the pressurized ambient air provided by the compressor 108 to other components of the air compression system 100. The adjustable regulator 132 may be downstream of the compressor 108 relative to the direction of ambient air flow through the system 50. The adjustable regulator 132 may be a pressure reducing regulator that reduces input pressure of the pressurized ambient air to a desired output value. The adjustable regulator 132 may include a restricting element such as a butterfly valve, poppet valve, globe valve, or other suitable structure to variably restrict fluid low therethrough. The adjustable regulator 132 may include a weight, a spring, a piston actuator, an electro-mechanical actuator, a diaphragm actuator in combination with a spring, or other suitable structure for applying force to the restricting element. The adjustable regulator 132 may be manually adjusted, e.g., by a user of the system. The adjustable regulator 132 may be in electronic communication with the control electronics 140 of the system 50 such that the control electronics 140 can control the adjustable regulator 132, e.g., to reduce the pressure of the pressurized ambient air to a specified pressure.

The air compression system 100 may include a heat exchanger 128 coupled between the compressor 108 and the disconnect coupling 104 of the filling station 106 to cool pressurized ambient air provided by the compressor 108. The heat exchanger 128 may remove heat HR2 from the pressurized ambient air provided by the compressor 108 to the disconnect coupling 104. The heat exchanger 128 may be downstream of the adjustable regulator 132 relative to the direction of ambient air flow through the system 50. The heat exchanger 128 may include, e.g., structure as described for the heat exchanger 124.

The air compression system 100 may include a tank 112 coupled between the heat exchanger 124 and the disconnect coupling 104 of the filling station 106 to store cooled pressurized ambient air. The tank 112 may serve as a pressurized air reservoir for the air compression system 100. The tank 112 may be downstream of the heat exchanger 128 relative to the direction of ambient air flow through the system 50. The tank 112 may be sized to, e.g., store a volume of pressurized ambient air that can provide filling of multiple chargers 200a, 200b sequentially and/or simultaneously and without requiring the compressor 108 to compress additional ambient air. In other words, the volume of the tank 112 may be a certain multiple larger than volumes of the chargers 200a, 200b. The tank 112 may comprise any materials and construction that is suitable for storing the pressurized ambient air at the pressures discussed herein. For example, the tank 112 may be a pressure vessel and include carbon fiber, high strength aluminum alloys, and/or have other suitable materials and construction for storing gas at the pressures discussed herein. A drain valve 114 may be connected to the tank 112, e.g., to drain moisture from the air compression system 100 (as shown in FIG. 3).

The air compression system 100 may include a coalescing filter 156. The coalescing filter 156 may be coupled between the compressor 108 and the disconnect coupling 104 of the filling station 106. The coalescing filter 156 may may be downstream of the tank 112 relative to the direction of ambient air flow through the system 50. The coalescing filter 156 may be configured to remove oil and moisture particles from the pressurized ambient air. For example, the coalescing filter 156 may have a filtration size of about 0.01 micrometer. Alternately, the coalescing filter 156 may have a higher or lower filtration size.

The air compression system 100 may include a sterile air filter 144 (as shown in FIG. 3). Alternative or additional, the filling stations 106 may include sterile air filters 144 (as shown in FIG. 2). The sterile air filter 144 may be coupled between the compressor 108 and the disconnect coupling 104 of the filling station 106. The sterile air filter 144 may be downstream of the coalescing filter 156 relative to the direction of ambient air flow through the system 50. The sterile air filter 144 may be configured to remove biological contaminants such as bacteria and microorganisms from the pressurized ambient air. For example, the sterile air filter 144 may have a filtration size of about 0.01 micrometer. Alternately, the sterile air filter 144 may have a higher or lower filtration size.

The air compression system 100 may include an adjustable regulator 136 coupled between the compressor 108 and the disconnect coupling 104 of the filling station 106 to control flow of pressurized ambient air to the disconnect coupling 104. The adjustable regulator 136 may control pressure of the pressurized ambient air provided to the disconnect coupling 104 of the filling station 106, e.g., the pressure of the pressurized ambient air output by the air compression system 100 to the one or more filling stations 106. The adjustable regulator 136 may be upstream (FIG. 2) or downstream (FIG. 3) of the coalescing filter 156.

The air compression system 100 may include one or more pressure sensors 170 connected to detect pressure of the pressurized ambient air, e.g., at various positions through the system 50. The pressure sensors 170 may be positioned upstream and/or downstream of various components of the air compression system 100, e.g., upstream and/or downstream of the adjustable regulator 136, the sterile air filter 144, the coalescing filter 156, and/or other components of the system 50. The pressure sensors 170 may be in electronic communication with the control electronics 140 of the system 50 such that the control electronics 140 can receive information from the pressure sensors 170 indicating the pressures detected by the respective pressure sensors 170.

The above-described components of the air compression system 100 may be coupled to provide flow of pressurized ambient air from one component to another via tubing 174 or other suitable structure for pneumatically coupling components. Although the above-described components are discussed as being components of the air compression system 100, such components may be additionally or alternately included in the one or more filling stations 106.

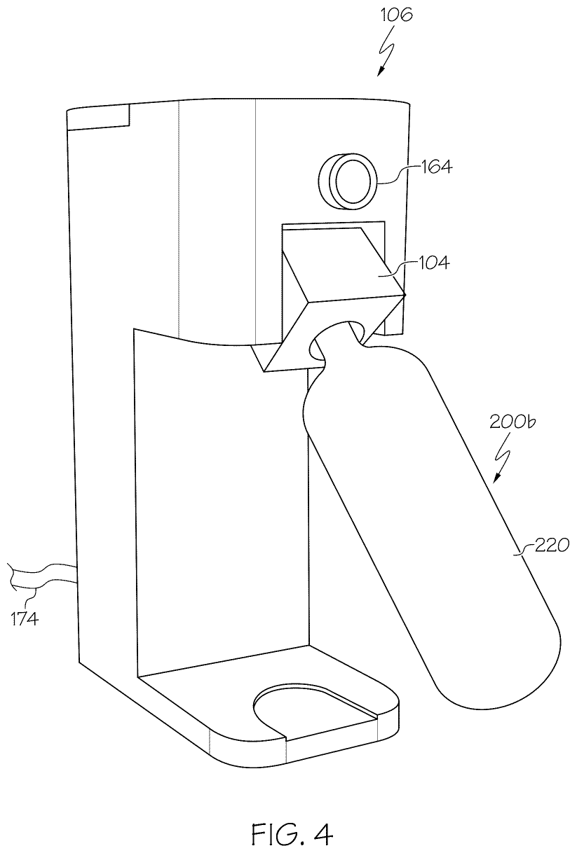

With refence to FIGS. 2-4, the one or more filling stations 106 may be included in the system 50 to enable one or more chargers 200a, 200b to be selectively connected to receive the pressurized ambient air. Each filling station 106 may include one or more disconnect couplings 104 that are selective couplable with corresponding disconnect couplings 204 of the chargers 200a, 200b. The disconnect couplings 104 may include a threaded fitting, a quick connect fitting, a push fitting, or other suitable structure for selectively pneumatically coupling components together. The disconnect couplings 104 of the one or more filling stations 106 may be coupled to the compressor 108 to receive pressurized ambient air, e.g., via the tubing 174 or the like connecting the air compression system 100 to the one or more filling stations 106.

With refence to FIGS. 2 and 3, each filling station 106 may include one or valves 152. The valves 152 may be configured to selectively permit and inhibit flow of pressurized ambient air to the one or more disconnect couplings 104. The valves 152 may be solenoid valves or other suitable structure for selectively permitting and inhibiting fluid flow. The valves 152 may be in electronic communication with the control electronics 140 of the system 50 such that the control electronics 140 can command the valves 152 to an open position permitting fluid flow and a closed position inhibiting fluid flow.

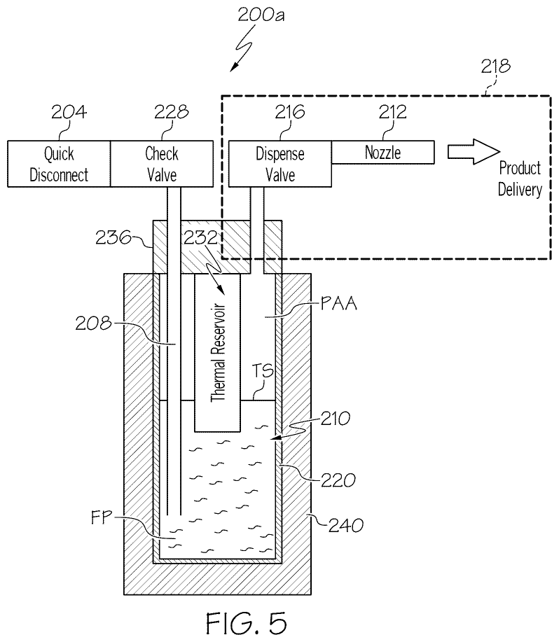

Each filling station 106 may include one or pressure sensors 148 connected to detect pressures of the pressurized ambient air provided to the disconnect couplings 104 of the one or more filling stations 106. The pressure sensor 148 may be upstream of the valve 152, as shown in FIG. 2. The pressure sensors 148 may be downstream of the valves 152, as shown in FIG. 3. The pressure sensors 148 downstream of the valves 152 may detect the pressure of pressurized ambient air provided to the disconnect couplings 104 and the chargers 200a, 200b connected thereto when the valves 152 are at the open position. The pressure sensors 148 downstream of the valves 152 may detect the pressure of pressurized ambient air PAA (see FIGS. 5-7) in the chargers 200a, 200b connected thereto when the valves 152 are at the closed position. The pressure sensors 148 may be in electronic communication with the control electronics 140 of the system 50 such that the control electronics 140 can receive information from the pressure sensors 148 indicating the pressure detected by the respective pressure sensors 148.

With continued refence to FIGS. 2 and 3, the system 50 may include a user interface 164 for presenting information to, and receiving instructions from, a user of the system 50. The user interface 164 may include one or more input devices that allow a user to input information to the control electronics 140. For example, and without limitation, the input device may be a keyboard, a mouse, a joystick, a touch screen, a remote control, a pointing device, a video input device, an audio input device, a haptic feedback device, and/or the like. The user interface 164 may include one or more output devices that allow a user to receive information from the control electronics 140. For example, and without limitation, the output device may be a display, a speaker, and/or the like. The display may include any medium capable of transmitting an optical output such as, for example, a cathode ray tube, light emitting diodes, a liquid crystal display, a plasma display, or the like. Moreover, the display may be a touchscreen that, in addition to providing optical information, detects the presence and location of a tactile input upon a surface of or adjacent to the display.

The control electronics 140 may be included in the system 50 to control and monitor various components of the system 50. The control electronics 140 may be any device or combination of components comprising a processor and non-transitory computer readable memory. The processor may be any device capable of executing the machine-readable instruction set stored in the non-transitory computer readable memory. Accordingly, the processor may be an electric controller, an integrated circuit, a microchip, a computer, or any other computing device. The non-transitory computer readable memory may comprise RAM, ROM, flash memories, hard drives, or any non-transitory memory device capable of storing machine-readable instructions such that the machine-readable instructions can be accessed and executed by the processor. The machine-readable instruction set may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable instructions and stored in the non-transitory computer readable memory. Alternatively, the machine-readable instruction set may be written in a hardware description language (HDL), such as logic implemented via either a field-programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components.

The control electronics 140 may be configured to, e.g., the memory may store instructions executable by the processor to, adjust the adjustable regulator 136 to control bubble formation in the whipped food product. For example, the control electronics 140 may adjust the adjustable regulator to provide 3000 to 4000 pounds per square inch. The control electronics 140 of the system 50 may adjust the adjustable regulator to control bubble formation in the whipped food product, e.g., based on information received from the user interface 164 indicating a type of food product FP in the chamber 210, based on a temperature, fat content, and solubility of the food product FP, etc., and such that a desired expansion ration of the pressurized ambient air in the food product FP is provided. Expansion ratios may be a function of one or more (or all) of: air pressure, temperature, fat content, and solubility, as described herein. Increased expansion ratios may be a function of one or more (or all) of: increased air pressure, lower temperature, higher fat content, and low solubility, as described herein. The control electronics 140 can control components of the system 50, e.g., the heat exchanger, 124, 128, the compressor 108, and the adjustable regulator 136 to produce whipped products (e.g., whipped cream) with high expansion ratios from an increased range of fat content products using ambient air at high pressures. For example, the control electronics 140 can control components of the system 50, e.g., the heat exchanger, 124, 128, the compressor 108, and the adjustable regulator 136 to produce whipped products with high expansion ratios (e.g., greater than or equal to 200% up to 350-400%) from an increased range of fat content products (e.g., 20-40% fat content) using ambient air at high pressures (e.g., 500 to 4000 psi). Higher pressures may correlate with lower fat content to effectuate the same or similar whipped consistencies. Higher pressures may correlate with higher expansion ratios. With higher pressure, more gas may be able to be dissolved into the food product FP the higher the expansion ratio produced. The higher pressures may accommodate for loss of pressure over time or any losses in pressure that may result in the filling of the chargers 200a, 200b.

The control electronics 140 may be configured to command the one or valves 152 to the open position and the closed position. The control electronics 140 may be configured to command the one or valves 152 to be open for a certain amount of time, until a certain pressure is achieved in the chargers 200a, 200b, based on an input to the user interface 164, etc.

The control electronics 140 may be configured to identify pressure leaks in the system 50 and/or the functionality of the filters 156, 144 and/or adjustable regulator 136, e.g., based on pressures detected by the pressure sensors 170. For example, the control electronics 140 may monitor fill pressure of each container 220 to determine whether a leak may exist and to determine where the leak may be in the system (e.g., downstream or upstream certain valves, in the container 220, in the tank 112, etc.). The control electronics 140 may determine fill characteristics at a baseline for when the system 50 is in working order and the characteristics can then be monitored to determine when and which characteristics change. For example, monitoring progression (increase) of manifold pressure while filling containers 220 as compared to individual and container pressures may allow determination of system level leaks. For example, monitoring compressor 108 current draw versus air output flow rate/pressure change may allow for an assessment of compressor health. As another example, if the detected pressure drops a predetermined amount, the control electronics 140 may generate a signal to indicate that the filter 144, 156 should be replaced or cleaned. The signal may be indicated on the user interface 164.

The system 50 may include a communication module 160 that provides electronic communication of information among various components of the system 50 and/or with other systems, computers, and the like. The communication module 160 can allow for remote access, monitoring, and/or analysis. In an example, communication module 160 can assist in evaluating use, efficiency of the system, leaks, and other analytics as may be desired. In an example, the communication module 160 can assist in determining and alerting to preventable maintenance. For example, the communication module 160 may send information received from the pressure sensors 148, 170, determinations may by the control electronics 140, user input to the user interface 164, and the like to a remote server computer (not shown). The communication module 160 may receive information from the remote server computer, such as software updates for the control electronics 140. The communication module 160 may include, for example, and without limitation, an antenna, a modem, LAN port, Wi-Fi card, WiMax card, Bluetooth hardware, IrDA hardware, Wireless USB hardware, Z-Wave hardware, ZigBee hardware, mobile communications hardware, near-field communication hardware, satellite communication hardware, cellular network communication hardware, and/or any wired or wireless hardware for communicating with other networks and/or devices. The cellular network may include, for example, and without limitation, a Global System for Mobile Communications (GSM) network, a 3G Universal Mobile Telecommunications System (UMTS) network, a 4G Long Term Evolution (LTE) network, a 5G network, and the like.

With reference to FIGS. 5-7, the one or more chargers 200a, 200b are included in the system 50 to store food product FP and pressurized ambient air PAA. The chargers 200a, 200b may be filled with pressurized ambient air PAA from the air compression system 100 by selectively attaching disconnect couplings 204 of the chargers 200a, 200b to a corresponding one of the disconnect couplings 104 of the filling station 106.

Each charger 200a, 200b includes a container 220 having a chamber 210 for holding food product FP. The container 220 may have one chamber 210 for holding food product FP, such as cream, and that is configured to receive pressurized ambient air PPA (e.g., from the air compression system 100 and at the various pressures discussed herein). In an embodiment, the container 220 may include separate chambers (not shown) for each the food product FP and the pressurized ambient air PPA. The container 220, may be made from a low weight composite such as carbon or Kevlar fiber, aluminum, and/or have other suitable materials and construction for storing gas at the pressures discussed herein.

The charger 200a, 200b may include a selectively attachable and removable silicone cover 240 for impact resistance, in an example. The charger 200a, 200b may have a rounded bottom (not shown) and the silicone cover 240 may also be shaped so as to provide a flat surface so that the charger 200a, 200b can stand upright when placed down by a user.

The charger 200a, 200b may further include a separate chamber (not shown) for a flavor or a flavor may be incorporated into the food product chamber 210. Alternately or additionally, the charger 200a, 200b may include a flavor injector 224 (schematically shown in FIG. 2). The flavor chamber and/or the flavor injector 224 incorporate flavors, such as vanilla, caramel, chocolate, hazelnut, and the like, into whipped product food product dispensed from the charger 200a, 200b. It is noted that flavor can be incorporated at any other stage of the system 50 as may be desired and may be incorporated into the food product FP prior to whipping or into the food product FP as the whipped food product is formed.

The chargers 200a, 200b may each have a disconnect coupling 204 that corresponds to one or more of the disconnect couplings 104 of one of the filling stations 106. The disconnect couplings 204 of each charger 200a, 200b are in fluid communication with the chamber 210 such that pressurized ambient air PAA can flow from the disconnect coupling 204 to the chamber 210 of the respective charger 200a, 200b. The disconnect couplings 204 are couplable to the disconnect couplings 104 of the filling stations 106 to provide pressurized ambient air PAA to the chamber 210 from the disconnect couplings 104. The disconnect couplings 204 may include a threaded fitting, a quick connect fitting, a push fitting, or other suitable structure of selectively pneumatically coupling components together. The disconnect couplings 204 provide selective attachment of the chargers 200a, 200b to the filling stations 106 so that the chargers 200a, 200b may be filled with the pressurized ambient air from the air compression system 100. In other words, the disconnect couplings 204 are configured to releasably and couple to the disconnect couplings 104 of the filling stations 106 such that the pressurized ambient air from the air compression system 100 can be provided to the disconnect couplings 204.

The chargers 200a, 200b may each have a check valve 228 connected between the disconnect coupling 204 and the chamber 210 of the respective charger 200a, 200b. The check valve 228 maintains pressure in the chamber 210. For example, the check valve 228 may be a one-way check valve that inhibits the pressurized ambient air PAA from escaping from the charger 200a, 200b via the disconnect couplings 204.

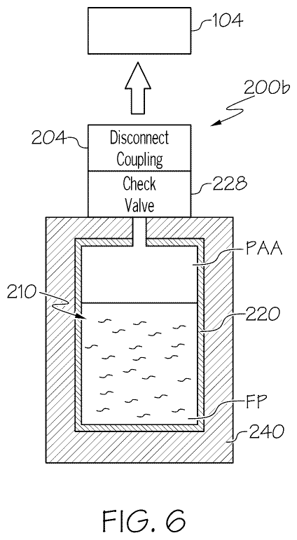

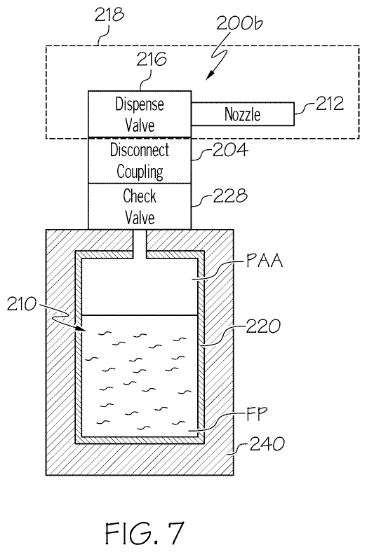

The chargers 200a, 200b may each have a dispensing assembly 218 that controls the flow and shape of whipped food product dispensed by the charger 200a, 200b. The dispensing assembly 218 may include a nozzle 212 and a dispense valve 216. The dispensing assembly 218, e.g., the dispense valve 216, may be the releasably attached to the container 220, e.g., via a removable cap 236 and as discussed below. The dispensing assembly 218, e.g., the dispense valve 216, may be couplable to the disconnect coupling 204, such that whipped food product formed by the pressurized ambient air PAA and the food product PA in the chamber 210 can flow through the disconnect coupling 204 to, and out of, the dispensing assembly 218 (see FIGS. 6 and 7). Removal of the dispensing assembly 218 aid may in cleaning the various components of the charger 200a, 200b and/or may permit food product FP to be added to the charger 200a, 200b.

With continued reference to FIGS. 5-7, the nozzle 212 may direct and shape whipped food product dispensed from the charger 200a, 200b. The nozzle 212 may be connected to the dispense valve 216 such that whipped food product formed by the food product FP and the pressurized ambient air PAA and dispensed by the dispense valve 216 can flow to, and through, the nozzle 212. The nozzle 212 may include an open end exposed to ambient air at atmospheric pressure. The whipped food product may expand when exposed to the ambient air at atmospheric pressure.

The dispense valve 216 is movable between a closed position that maintains the food product FP and the pressurized ambient air PAA in the chamber 210 and an open position that permits the food product FP and the pressurized ambient air PAA in the chamber 210 to be dispensed. An actuator (not shown) for the dispense valve 216 may selectively open and close the dispense valve 216. The actuator may be a trigger, button, or other suitable structure for imparting force to move the dispense valve 216 from the closed position to the open position. Actuation of the dispense valve 216 may open the check valve 228.

With reference to FIG. 5, the charger 200a may include the removable cap 236, e.g., the cap is removable, e.g., for cleaning and for adding food product FP to the container 220. The removable cap 236 is connectable to the container 220 to enclose the chamber 210. For example, removable cap 236 may threadedly engage the container 220 at an open end of the chamber 210. The disconnect coupling 204, the dispense valve 216, and the nozzle 212 may be attached to the removable cap 236. The dispense valve 216 and nozzle 212 may be removable from the removable cap 236.

The charger 200a may include a thermal reservoir 232 to provide cooling (or heating) as may be desired. The thermal reservoir 232 may be formed from high heat capacity material and may be attached to the removable cap 236 of the charger 200a, 200b. The thermal reservoir 232 may be disposed in the chamber 210, e.g., when the removable cap 236 is connected to a top of the container 220. The thermal reservoir 232, along with other components of the charger 200a, may be cooled in a refrigerator or the like.

The charger 200a may include a gas inlet tube 208 extending to a bottom half of the chamber 210. The gas inlet tube 208 may be operativity connected to the disconnect coupling 204 such that pressurized ambient air PA A provided to the chamber 210 by the disconnect coupling 204 flows through the gas inlet tube 208. The gas inlet tube 208 may provide pressurized ambient air PAA into the food product FP disposed in the chamber 210. For example, the gas inlet tube 208 may extend below a top surface TS of the food product FD. The pressurized ambient air PAA delivered though the gas inlet tube 208 may from bubbles in the food product FP to aid in whipping the food product FP.

Turning to FIG. 8, a flow chart illustrating an embodiment of a method 800 for using ambient air to produce whipped food product is shown. The method 800 may include a step 810 at which food product FP is placed into the chamber 210 of a charger 200a, 200b. The food product FP may be cream. In an embodiment, the food product FP may include cream and optional emulsifiers or other foaming agents. The optional emulsifiers or other foaming agents may promote or maintain a high expansion ratio of the whipped product. The optional emulsifiers or other foaming agents may promote or maintain a high expansion ratio of the whipped product when using products that have lower fat content or lower pressurized ambient air, or the like. In an embodiment, the fat content of the food product FP or cream may be 27% to 36%. In an embodiment, the fat content of the food product FP or cream may be 20% to 40%. In an embodiment, the fat content of the food product FP or cream may be 20% and greater. In an embodiment, the fat content of the food product FP or cream may be 40% and lower. It is noted that other fat contents may be used and other food products FP that do not necessarily include fat (e.g., skim milk, vegan milk or milk alternatives, water, flavored waters, etc.) may be used.

A step 820 of the method 800 may include connecting the charger 200a, 200b with the food product FP therein to a filling station 106. For example, connecting the charger 200a, 200b to the filling station 106 may include coupling a disconnect coupling 104 of the filling station 106 to a disconnect coupling 204 of the charger 200a, 200b.

A step 830 of the method 800 may include pressurizing atmospheric ambient air AAA to provide pressurized ambient air. The atmospheric ambient air AAA may be pressurized to the various pressures discussed herein. The pressure of the pressurized ambient air may be controlled by the adjustable regulator 132, e.g., as discussed herein. The atmospheric ambient air AAA may be pressurized with the compressor 108 of the air compression system 100 and stored in the tank 112. The step 830 may be performed before, during, or after the step 810 and the step 820.

A step 840 of the method 800 may include filtering the pressurized ambient air to provide filtered pressurized ambient air. The pressurized ambient air may be filtered, e.g., with the various filters 116, 144, 156 discussed herein.

A step 850 of the method 800 may include incorporating the filtered pressurized ambient air into the food product FP placed into the chamber 210 at the step 810. The filtered pressurized ambient air may be incorporated into the food product FP by providing the pressurized ambient air to the chamber 210 of the charger 200a, 200b with the filling station 106, e.g., via the coupling of the disconnect coupling 104 of the filling station 106 with the disconnect coupling 204 of the charger 200a, 200b. The adjustable regulator 136 may control pressure of the pressurized ambient air provided to the chamber 210 of the charger 200a, 200b, e.g., as commanded by the control electronics 140. The pressurized ambient air may be provided to the chamber 210 of the charger at a pressure of 3000 to 4000 pounds per square inch, e.g., via control of the adjustable regulator 136. The pressurized ambient air may be provided to the chamber 210 at other pressures, e.g., at about 500 to 4000 psi, at about 3000 to 4000 psi, at about 3000 psi and greater, and as otherwise described herein. The pressurized ambient air may be provided to the chamber 210 with the gas inlet tube 208, e.g., such that the pressurized ambient air is incorporated into the food product FP. In an embodiment, the pressures in the air compression system 100 and the chargers 200a, 200b may be generally the same. In an embodiment, the pressures in the air compression system 100 and the chargers 200a, 200b may be different. In an embodiment, the pressures in the air compression system 100 may be higher than the pressures in the chargers 200a, 200b.

A step 860 of the method 800 may include disconnecting the charger 200a, 200b from the filling station 106, e.g., after the step 850. For example, disconnecting the charger 200a, 200b from the filling station 106 may include uncoupling the disconnect coupling 104 of the filling station 106 from the disconnect coupling 204 of the charger 200a, 200b.

A step 870 of the method 800 may include dispensing whipped food product from the nozzle 212 of the charger 200a, 200b. The whipped food product may be dispensed, for example, by actuating the dispense valve 216 of the charger 200a, 200b. The charger 200a, 200b may be held upside down while opening the dispense valve 216.

From the above, it is to be appreciated that defined herein are systems and methods for producing whip food product with pressurized ambient air to and thereby minimizing or limiting the use and inclusion of nitrous oxide.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A system for producing whipped food product, the system comprising:
a compressor having an inlet that receives ambient air and an outlet that provides pressurized ambient air;
a first disconnect coupling coupled to the compressor to receive the pressurized ambient air; and
a charger comprising:
a container having a chamber for holding a food product,
a second disconnect coupling in fluid communication with the chamber and couplable to the first disconnect coupling to provide the pressurized ambient air to the chamber from first disconnect coupling,
a dispense valve, and
a nozzle connected to the dispense valve.

2. The system of claim 1, wherein the charger includes a check valve connected between the second disconnect coupling and the chamber.

3. The system of claim 1, wherein the charger includes a removable cap that is connectable to the container to enclose the chamber.

4. The system of claim 3, wherein the second disconnect coupling and the dispense valve and the nozzle are attached to the removable cap.

5. The system of claim 1, wherein the charger includes a thermal reservoir disposed in the chamber.

6. The system of claim 1, wherein the charger includes a gas inlet tube extending to a bottom half of the chamber.

7. The system of claim 1, wherein the dispense valve is couplable to the second disconnect coupling.

8. The system of claim 1, wherein the compressor includes a heat exchanger to cool the compressor.

9. The system of claim 1, further comprising a heat exchanger coupled between the compressor and the first disconnect coupling to cool the pressurized ambient air provided by the compressor.

10. The system of claim 9, further comprising, a tank coupled between the heat exchanger and the first disconnect coupling to store the cooled pressurized ambient air.

11. The system of claim 1, further comprising an adjustable regulator coupled between the compressor and the first disconnect coupling to control flow of the pressurized ambient air to the first disconnect coupling.

12. The system of claim 11, further comprising control electronics that adjust the adjustable regulator to control bubble formation in the whipped food product.

13. The system of claim 12, wherein the control electronics adjust the adjustable regulator to provide 3000 to 4000 pounds per square inch.

14. The system of claim 1, further comprising a sterile air filter coupled between the compressor and the first disconnect coupling to clean the pressurized ambient air.

15. A method for producing whipped food product, the method comprising:
placing food product into a chamber of a charger;
connecting the charger to a filling station;
providing pressurized ambient air to the chamber of the charger with the filling station;
disconnecting the charger from the filling station; and
dispensing a whipped food product from a nozzle of the charger by actuating a dispense valve of the charger.

16. The method of claim 15, wherein the food product placed in the chamber is cream.

17. The method of claim 15, wherein connecting the charger to the filling station includes coupling a first disconnect coupling of the filling station to a second disconnect of the charger.

18. The method of claim 15, wherein the pressurized ambient air is provided to the chamber of the charger at a pressure of 500 to 4000 pounds per square inch.

19. The method of claim 15, wherein the pressurized ambient air is provided to the chamber with a gas inlet tube that extends to a bottom half of the chamber.
